(19) United States
(12) Patent Application Publication
(10) Pub. No.: US 2007/0065146 A1
(43) Pub. Date: Mar. 22, 2007

(54) Method and arrangement for the transmission of working signals and protection signals via optical data networks

(76) Inventors: Nancy Hecker, Munich (DE); Alexander Richter, Munich (DE); Carlos Enrique Sabido Ponce, Oldenzaal (NL)

Correspondence Address: Siemens Corporation;Intellectual Property Department, 170 Wood Avenue South, Iselin, NJ, 08830, US

(21) Appl. No.: 10/547,152

(22) PCT Filed: Jan. 23, 2004
(86) PCT No.: PCT/EP04/00573

§ 371 Date: Oct. 24, 2006

(30) Foreign Application Priority Data
Feb. 26, 2003 (DE) 103 08 306.5

(51) Int. Cl. H04B 10/00

(52) U.S. Cl. 398/4

(57) ABSTRACT

According to the invention, working signals are transmitted between network elements via a first communication path. The protection signals are transmitted continuously or in case of a fault at the same wavelength as the working signals via a second communication path of an optical network while the polarization of the protection signals is adjusted orthogonal to the polarization of additional working signals which are transmitted at the same wavelength via sections of the second communication path such that no wavelengths need to be kept clear for protection signals.

### CROSS REFERENCE TO RELATED APPLICATIONS

This application is the US National Stage of International Application No. PCT/EP2004/000573, filed Jan. 23, 2004 and claims the benefit thereof. The International Application claims the benefits of German application No. 10308306.5, filed Feb. 26, 2003, both applications are incorporated by reference herein in their entirety.

### FIELD OF INVENTION

The invention relates to method and an arrangement for the transmission of working signals and protection signals via optical data networks.

### SUMMARY OF THE INVENTION

Today, because of their wide transmission bandwidth and their low attenuation, glass fibers are used for the transmission of digital signals with high data rates. To enable the transmission capacity of the glass fiber to be utilized, a number of signals featuring different wavelengths (WDM signals) are transmitted in parallel over a fiber. In this case a number of transmission channels are combined into bands. 2-fiber systems are mostly used in which the data signal is transmitted in one direction in each case. Single-fiber systems are however also known, with which different frequency bands or interleaved data signals with particular frequencies are transmitted in either direction. 4-fiber systems are also known for increasing the transmission capacity or for providing protection switching.

A ring structure shown in FIG. 1 is described in a contribution to the “22nd Conference on Optical Communication—ECOC 96, Oslo, WeB.2.3, 178 pages 3.51-3.54 “First results of an experimental Coloured Section Ring”, in which adjacent ADD/DROP multiplexers are connected to each other bidirectionally via two fibers in each case. For each transmission section between two adjacent DROP multiplexers only one wavelength is needed for both directions of transmission on each fiber. However different wavelengths are used on all transmission sections of the ring. The signals are added or dropped via optical ADD/DROP multiplexers which contain optical fibers. If for example a working connection is interrupted by a broken fiber, a protection connection is established via the (mostly) longer intact ring section using the same wavelength, i.e. the working signals previously sent over the interrupted section are “looped back” and transmitted over the intact sections. The advantage of this is that the wavelength does not need to be converted. Instead of for an individual wavelength this method can naturally also be employed for a number of wavelengths and transmission bands. Although the method offers the advantage that the wavelength for protection connections does not need to be converted, it does however sharply reduce the transmission capacity.

The object of the invention is to provide protection connections which do not have an adverse effect on transmission capacity.

This object is achieved by the claims, resulting in orthogonally polarized protection signals being transmitted. Furthermore, a suitable arrangement for this is also claimed.

The method in accordance with the invention is particularly advantageous to implement in ring networks in which merely the transmitted signals of the two elements adjacent to an interruption point are looped back in the opposite direction using a polarization setter.

The method in accordance with the invention can advantageously be used for 1:1 protection (the disturbed signal is diverted via an undisturbed connection path) and for 1+1 protection (a protection signal is always transmitted as well) for all network structures, especially for ring structures.

The invention will now be explained in more detail below on the basis of an exemplary embodiment.

### BRIEF DESCRIPTION OF THE DRAWINGS

FIG. 1 shows a 2-fiber ring network,

FIG. 2 shows the 2-fiber ring network with protection switching,

FIG. 3 shows a network element,

FIG. 4 shows a receive section of the network element

FIG. 5 shows a 2-fiber ring network with 1+1 protection,

FIG. 6 shows a protection-switching device, and

FIG. 7 shows a 4-fiber ring network with span protection.

### DETAILED DESCRIPTION OF INVENTION

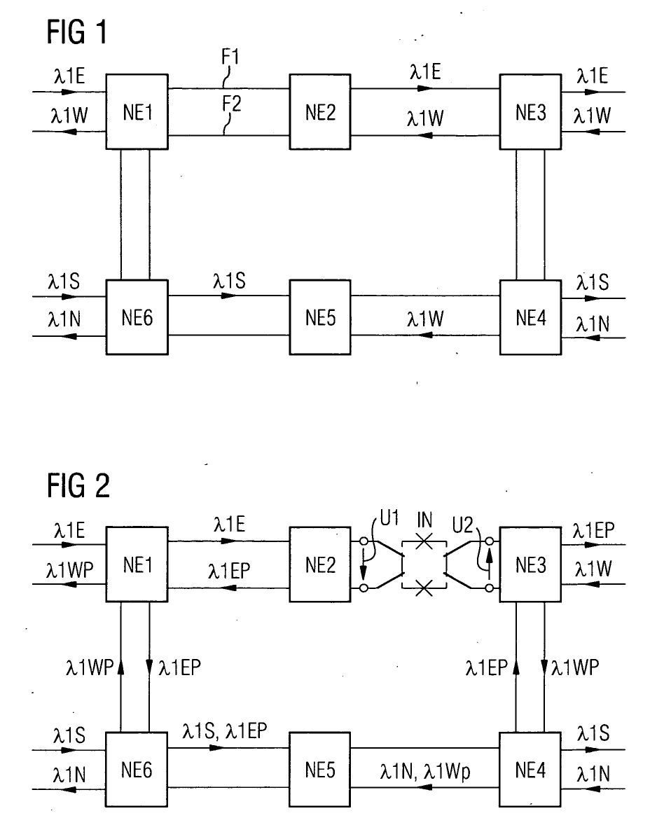

FIG. 1 shows an extended 2-fiber ring network structure. A ring network formed with two fibers F1 and F2 features the network elements NE1 to NE6. For a connection (channel) between the network element NE1 and the network element NE3 a wavelength λ1 is used, with a working signal λ1E being transmitted in an easterly direction over the first fiber F1 and a working signal λ1W with the same wavelength being transmitted in the opposite direction. The same wavelength can also be used for transmission for example between the network elements in NE4 and NE6. The corresponding signals are labeled λ1S and λ1N. Naturally there will generally be more channels with other wavelengths present for connecting the other network elements, but these can be left out of our considerations for the purposes of explaining the invention.

FIG. 2 shows a fiber break at an interruption point between the network elements. The connection path NE1-NE2-NE3 is interrupted. In the known way the send signals must now be “Iooped back” by the network elements NE2 and NE3 adjacent to the interruption point through switchover devices U1 and U2 (possibly there is also already a loopback in the network elements NE2 and NE3) and is transmitted in the opposite direction via the undisturbed part of the ring network, the second connection path NE1-NE6-NE5-NE4-NE3. The signal λ1E is consequently transmitted over the other fiber F2 as protection signal λ1EP and the signal λ1W is transmitted over fiber F1 as protection signal λ1WP. So that a signal of this wavelength does not collide with other signals of the same wavelength, in a conventional system either this wavelength would have to be kept free on the remaining part of the ring, which results in the Coloured Section Ring described at the start, or the wavelength must be converted into another wavelength used for protection data connections only.

In the case shown in FIG. 2 signals with the same wavelength λ1 are transmitted between the network elements NE1 and NE3 and also the network elements NE4 and NE6. The working signals transmitted between the network elements NE4 and NE6 are labeled λ1S and λ1N in order to distinguish between them. Before the merging of the signals λ1S and λ1EP or λ1N and λ1WP the signals transmitted over a common fiber in each case must be (at least approximately) aligned orthogonally polarized to each other. This is undertaken for the signals λ1S and λ1EP expediently in the network element NE6 by changing the polarization of the protection signal λ1EP.

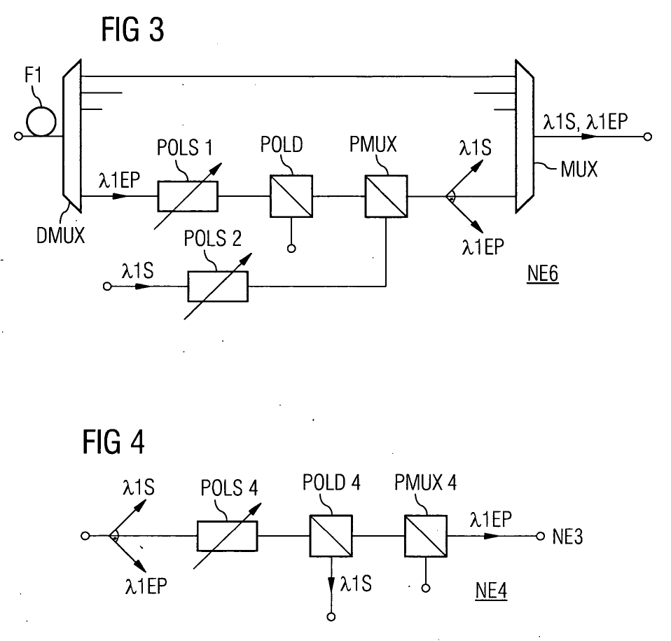

The main parts of the network element NE6 are shown in FIG. 3. The demultiplexer DMUX splits a received WDM (Wavelength Division Multiplex) signal up into individual signals λ1 to λn. The signal λn is (together with other signals) “looped through” and merged in the multiplexer MUX again with possibly newly added signals into a WDM signal.

The protection signal λ1S fed via the series circuit of a polarization setter POLS1, a polarization divider POLD and a polarization multiplexer PMUX. The polarization divider POLD is not required here for the circuit to function but must be present in each network element in order to separate a working signal from the protection signal and enable one of the signals to be dropped. In this example the protection signal λ1EP is however looped through the network element. In the polarization multiplexer PMUX the protection signal λ1EP is merged with the working signal λ1S of the same wavelength. If the polarization of the signal λ1S is also not known, the two polarization setters POLS1 and POLS2 are required. The same applies to the protection signal λ1WP, for which the polarization is set in the network element NE4 orthogonally to the polarization of the signal λ1N.

In the network element NE4 the signal λ1S is dropped and the protection signal λ1EP looped through. In FIG. 4 only the parts of the network element NE4 significant for the splitting of the working and protection signal are shown. These are the polarization setter POLS4 and the polarization divider POLD4, which may have a polarization multiplexer PMUX4 connected downstream if necessary.

The working signal λ1S and the protection signal λ1EP are fed to the polarization setter POLS4 which matches the polarizations of these signals to the orientation of the polarization divider POLD4. This splits the signal mixture into the working signal λ1S which is dropped here and the protection signal λ1EP which is forwarded to the network element NE3.

The signal λ1N sent in the opposite direction is merged in accordance with FIG. 3 with the protection signal λ1WP.

The network element NE3, like all network elements, has the same circuit arrangement. The protection signal λ1EP is received after being fed back to the same port and is dropped there.

The mutual influence of working signal and orthogonally polarized protection signal is slight in transmission links with Polarization Mode Dispersion (PMD) whenever the transmitted data signals exhibit the same data rates and (their bits or modulation section) have a specific phase angle to each other (with NRZ 0°). Therefore a synchronization of the protection signal can be worthwhile.

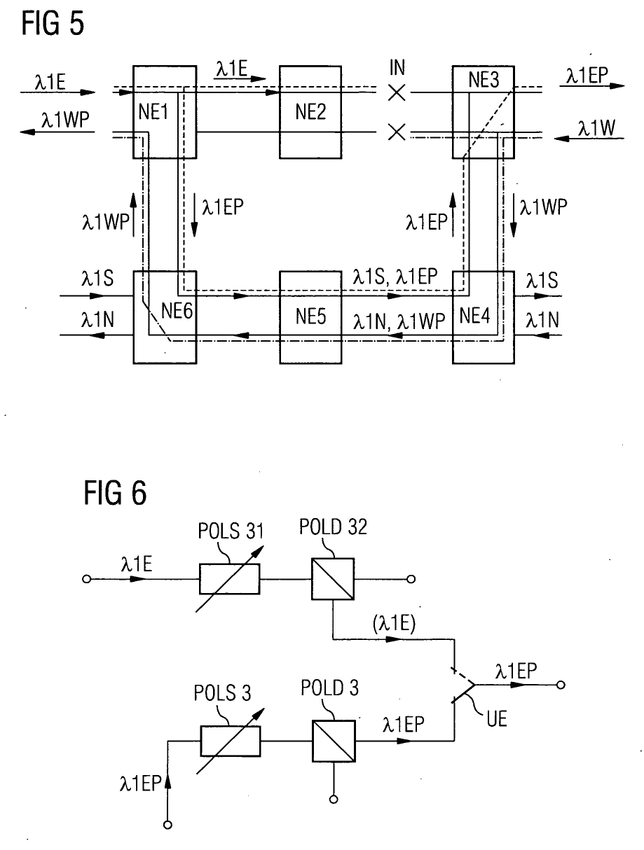

Instead of the 1:1 protection described, a 1+1 protection can be used, in which the protection signal is transmitted continuously and therefore a faster switchover is made possible. A ring network with 1+1 protection is shown in FIG. 5. The signal λ1E—shown by a dashed line—is transmitted from the network element NE1 via the network element NE2 to the network element NE3 in the opposite direction—shown by dashed and dotted line—the signal λ1W. Simultaneously the protection signal λ1EP, also shown by a dashed line, is transmitted via the network element NEG, NE5 and NE4, and in the opposite direction the protection signal λ1WP, also shown as a dashed and dotted line is transmitted. In the event of a fault no loop is created through the network elements NE2 and NE3, since the protection signals, also shown dashed or dashed and dotted, can already be sent and received via the intact loop section. In the network element there only needs to be a switchover between the working signal and the associated orthogonally polarized protection signal. This is shown simplified in FIG. 6. The working signal is fed from a first access port via a polarization setter POLS3 with downstream polarization divider POLD4 while the protection signal is fed via a second input port and a polarization setter POLS4 with downstream polarization divider POLDS. In the protection case there only needs to be a switchover between these two receiver signals λ1E and λ1EP by a switchover device UE.

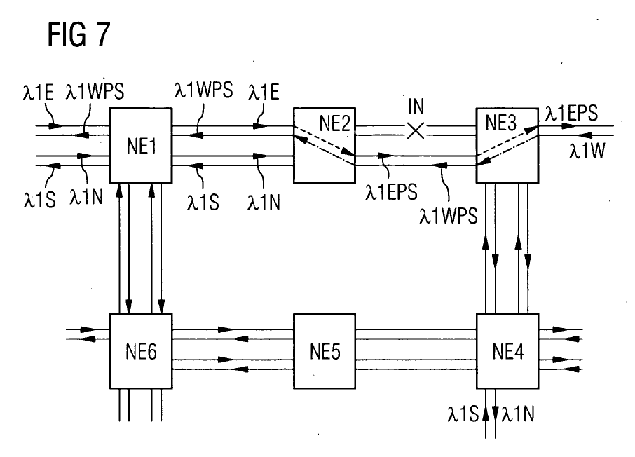

FIG. 7 shows a 4-fiber ring network. Two fiber pairs F1, F2 and F3, 4 are laid spatially separated. In the case of a fault or interruption of one of the fiber pairs F1, F2 the signals λ1E and λ1W transmitted between the network elements NE1 and NE3 on the fibers F1 and F2 are diverted in the network elements NE2 and NE3 (NE1 and NE3 is also possible) via the fibers F3 and F4, in which case they are polarized orthogonally to the further working signals λ1S and λ1N exhibiting the same working signals. Thus the disturbed fiber section (span) NE2-NE3 is bridged without adversely affecting the further working signals.

It should also be added that both with 2-fiber ring networks and also with 4-fiber ring networks all the wavelengths of the orthogonal protection “channels” can be used for low-priority traffic, which is then interrupted however in the event of a fault, in order to transmit protection signals with higher priority.

1.-10. (canceled)

11. A method for transmitting working signals between network elements via a first connection path and for transmitting protection signals between network elements via a second connection path of an optical network, the method comprising:
transmitting the protection signals via the second connection path, the protection signals having the same wavelengths as the working signals, wherein
a polarization of the protection signals is orthogonal relative to a polarization of further working signals transmitted over at least sections of the second connection path, the further working signals having the same wavelength as the protection signals.

12. The method in accordance with claim 11, wherein in case of a 2-fiber ring network with 1:1 protection, in the event of a fault, the working signal previously transmitted over one of the fibers of the first connection path is looped back as a protection signal and is transmitted via the other fiber over the undisturbed second connection path.

13. The method in accordance with claim 12, wherein a network element adjacent to an interruption point or any other network element receives at least one of the protection signals and feeds back the at least one protection signal to an input port of an associated working signal or further working signal.

14. The method in accordance with claim 11, wherein in case of a 2-fiber ring network with 1+1 protection, protection signals are continuously transmitted over the second connection path.

15. The method in accordance with claim 12, wherein a working signal or a further working signal, and a protection signal are tapped from a network element, the working signal or the further working signal, and the protection signal are separated by a polarization divider.

16. The method in accordance with claim 14, wherein a working signal or a further working signal, and a protection signal are tapped from a network element, the working signal or the further working signal, and the protection signal are separated by a polarization divider.

17. The method in accordance with claim 12, wherein in a network element, in which the working signal is received at a first input port and the assigned protection signal is received at a second input port, a switchover between working signal and protection signal is undertaken by a switchover device.

18. The method in accordance with claim 14, wherein in a network element, in which the working signal is received at a first input port and the assigned protection signal is received at a second input port, a switchover between working signal and protection signal is undertaken by a switchover device.

19. The method in accordance with claim 11, wherein
first and a second network elements are part of a ring network having first and second fiber pairs, wherein
protection signals are transmitted on the second fiber pair between the first and second network elements in case of failure of the first fiber pair, and wherein
the protection signals have a polarization orthogonal relative to the further working signals transmitted on at least sections of the second fiber pair.

20. The method in accordance with claim 11, wherein
first and a second network-elements are part of a ring network having first and second fiber pairs, wherein
protection signals are continuously transmitted on the second fiber pair between the first and second network elements, wherein
the protection signals have a polarization orthogonal relative to the further working signals transmitted on at least sections of the second fiber pair.

21. The method in accordance with claim 11, wherein in the fault-free case working signals of lower priority are transmitted instead of the protection signals.

22. The method in accordance with claim 12, wherein in the fault-free case working signals of lower priority are transmitted instead of the protection signals.

23. The method in accordance with claim 11, wherein signals polarized orthogonally to each other are transmitted bit-synchronously with the same data rate.

24. The method in accordance with claim 12, wherein signals polarized orthogonally to each other are transmitted bit-synchronously with the same data rate.

25. The method in accordance with claim 13, wherein signals polarized orthogonally to each other are transmitted bit-synchronously with the same data rate.

26. The method in accordance with claim 14, wherein signals polarized orthogonally to each other are transmitted bit-synchronously with the same data rate.

27. The method in accordance with claim 15, wherein signals polarized orthogonally to each other are transmitted bit-synchronously with the same data rate.

28. The method in accordance with claim 17, wherein signals polarized orthogonally to each other are transmitted bit-synchronously with the same data rate.

29. An arrangement for transmission of working signals between network elements via a first connection path and of protection signals via a second connection path of an optical network, wherein the network elements comprise:
switchover devices on the transmit and receive side to switch over from the first connection path to the second connection path;
polarization setters for setting the polarization of a protection signal and of a further working signal transmitted over the same fiber and featuring the same wavelength orthogonally to each other; and
polarization dividers for separating the protection signal from the further working signal.
